(19) United States
(12) Patent Application Publication
(10) Pub. No.: US 2013/0093892 A1
(43) Pub. Date: Apr. 18, 2013

(54) RECOGNITION OF A ROAD ILLUMINATION

(71) Applicant: Robert Bosch GmbH, Stuttgart (DE)

(72) Inventor: Gregor SCHWARZENBERG, Calw (DE)

(73) Assignee: Robert Bosch GmbH, Stuttgart (DE)

(21) Appl. No.: 13/652,725

(22) Filed: Oct. 16, 2012

(30) Foreign Application Priority Data
Oct. 17, 2011 (DE) 10 2011 084 613.1

(51) Int. Cl. H04N 7/18

(52) U.S. Cl. 348/148; 348/E07.085

(57) ABSTRACT

In a method for recognizing a road illumination, light reflected at a road surface is taken by a camera and a modulation over time of the brightness of the reflected light is detected.

### BACKGROUND OF THE INVENTION

1. Field of the Invention

The present invention relates to a device and a method for recognizing a road illumination, as well as a motor vehicle having a device for recognizing a road illumination.

2. Description of the Related Art

It is known that one may equip motor vehicles with video-based driver assistance systems which, during travel at night, follow light objects and classify them as being from non-host vehicle traffic, as reflections or as road illumination. For the classification of a followed light object as a road lamp, the position and the motion of the light object in the image captured by the camera is frequently evaluated. This is described, for example, in U.S. Pat. No. 5,837,994. It is also known that one may carry out a frequency analysis of a light emitted by a light object, in order to classify the light object. U.S. Pat. No. 5,837,994 mentions the additional possibility of detecting a modulation over time, caused by an operation using alternating voltage, of the intensity of a light emitted by a light object, in order to classify the light object as road illumination.

It is known that, from the presence of a road illumination, one may conclude that the motor vehicle is moving within a locality. It is also known that one should adjust the vehicle illumination of a motor vehicle within closed localities.

It has turned out that the direct following of light objects using a camera leads to faulty classification of the light object in many cases. Thus, for example, footpath illuminations, flood lights of a football field, lamps on houses and other light sources are erroneously classified as road illumination. An additional problem is that the lens coverage of a camera used for lane detection is not suitable for the direct recording of road illumination, which requires providing additional cameras.

### BRIEF SUMMARY OF THE INVENTION

An object of the present invention is therefore to provide an improved method for recognizing a road illumination. Another object of the present invention to provide an improved device for recognizing a road illumination. An additional object of the present invention is to provide a motor vehicle having an improved device for recognizing a road illumination.

In a method according to the present invention for recognizing a road illumination, light reflected at a road surface is taken by a camera and a modulation over time of the brightness of the reflected light is detected. This method advantageously requires no direct visibility of the light source for the camera. Therefore, advantageously for the method, a camera aligned downwards is able to be used, which otherwise is used for lane detection.

A modulation over time of the brightness of the reflected light is preferably detected as a function of a network frequency of a power supply system. The method advantageously utilizes the fact that a road illumination is operated using alternating voltage, whereas vehicle illuminations are operated using direct voltage, so as to distinguish road illumination from other light sources.

In one specific embodiment of the method, the reflected light is taken using a bimodally regulated camera. A bimodally regulated camera advantageously permits reliable detection of a modulation over time of the brightness of the reflected light.

It is expedient if the reflected light is taken using the image refresh rate, a network frequency of a power supply system being an integral multiple of the image refresh rate. The modulation over time of the brightness of the reflected light may then advantageously be detected particularly simply and reliably.

In another specific embodiment of the method, the reflected light is taken using a monomodally regulated camera. A monomodally regulated camera also advantageously permits reliable detection of a modulation over time of the brightness of the reflected light.

In this specific embodiment, it is expedient that the reflected light is taken using an image refresh rate which is not an integral multiple of a network frequency of a power supply system. by doing this, one is able to avoid the masking of the modulation over time of the brightness of the reflected light by the image refresh rate of the monomodally regulated camera.

A device for recognizing a road illumination, according to the present invention, includes a camera that is provided to take light reflected at the road surface and an evaluation unit that is developed to detect a modulation over time of the brightness of the reflected light. The camera of this device may advantageously be aligned onto the road surface, and also be used for lane detection. An additional advantage is that the camera records only the light sources that are actually illuminating the road. Consequently, illuminations from buildings and footpaths, which are not illuminating the road, are not recorded in the first place.

In one specific embodiment of the device, the camera is a bimodally regulated camera which has an image refresh rate, a network frequency of a power supply system being an integral multiple of the image refresh rate. The device then advantageously permits reliable detection of a modulation over time of the brightness of the reflected light.

In still another specific embodiment of the device, the camera is a monomodally regulated camera which has an image refresh rate which is not an integral multiple of a network frequency of a power supply system. In this specific embodiment too, the device advantageously permits the reliable detection of a modulation over time of the brightness of the reflected light.

A motor vehicle according to the present invention has a device of the abovementioned type. The motor vehicle is then advantageously able to recognize independently the presence of a road illumination.

The present invention will now be described in greater detail in the following text with reference to the attached figures.

### BRIEF SUMMARY OF THE DRAWINGS

FIG. 1 shows a schematic representation of a motor vehicle on a road having road illumination.

FIG. 2 shows a first diagram for explaining a light source whose brightness is not modulated over time.

FIG. 3 shows a second diagram for explaining the detection of a non-modulated light source.

FIG. 4 shows a third diagram for explaining a light source having a brightness modulated over time.

FIG. 5 shows a fourth diagram for explaining the detection of the light source modulated over time.

### DETAILED DESCRIPTION OF THE INVENTION

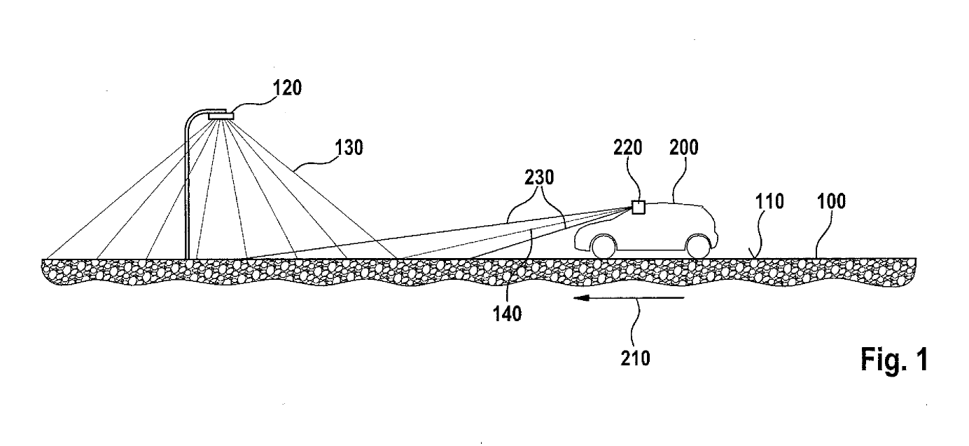

FIG. 1 shows a greatly schematic representation of a motor vehicle 200, which is traveling along a road 100. Road 100 has a road surface 110. Motor vehicle 200 is moving in a travel direction 210.

Road 100 has a road illumination 120. Road 100 may, for example, be a street in a town. In the example shown, road illumination 120 is a street lamp. Road illumination 120 emits light 130 in the direction of road surface 110. Light 130 is partially reflected at road surface 110 and cast back as reflected light 140 from road surface 110.

Motor vehicle 200 has a camera 220, whose lens coverage 230 is directed onto an area of road surface 110, that lies ahead of motor vehicle 200 in the direction of travel 210. Camera 220 may, for instance, be used for lane detection that is automatically carried out by a driver assistance system of motor vehicle 200. However, the camera also records a part of light 140 of road illumination 120 reflected by road by road surface 110. Camera 220 is additionally able to record the light emitted by the tail lights of preceding motor vehicles, and the light emitted by the headlights of oncoming vehicles.

Motor vehicle 200 is equipped with a device used to recognize the presence of road illumination 120. To do this, the device detects that reflected light 140 recorded by camera 220 of motor vehicle 200 was emitted by road illumination 120.

Road illuminations such as road illumination 120 of FIG. 1 are operated using alternating voltage from a general power supply system. This alternating voltage has a frequency of 50 Hz or 60 Hz, for example, and in the case of road lamps based on LED, even higher frequencies are achieved. Because of the operation using alternating voltage, the intensity of light 130 emitted by road illumination 120 is modulated over time and pulsed, for example, using a frequency of 100 Hz or 120 Hz. Headlights of motor vehicles, on the other hand, are operated using direct voltage. Therefore, the intensity of a light emitted by a vehicle headlight is not modulated over time and does not pulsate.

Camera 220 of motor vehicle 200 may be a monomodally regulated camera or an at least bimodally regulated camera. As a monomodally regulated camera a camera is designated, in the context of this description, which takes images at a fixed image refresh rate, each of the images being taken so as to have the same exposure time. As an at least bimodally regulated camera a camera is designated, in the context of this description, which takes images at a fixed image refresh rate, each of the successive images being taken, however, so as to have exposure times of different lengths. For instance, a bimodally regulated camera is able to take every second image at a short exposure time and every other second image at a long exposure time.

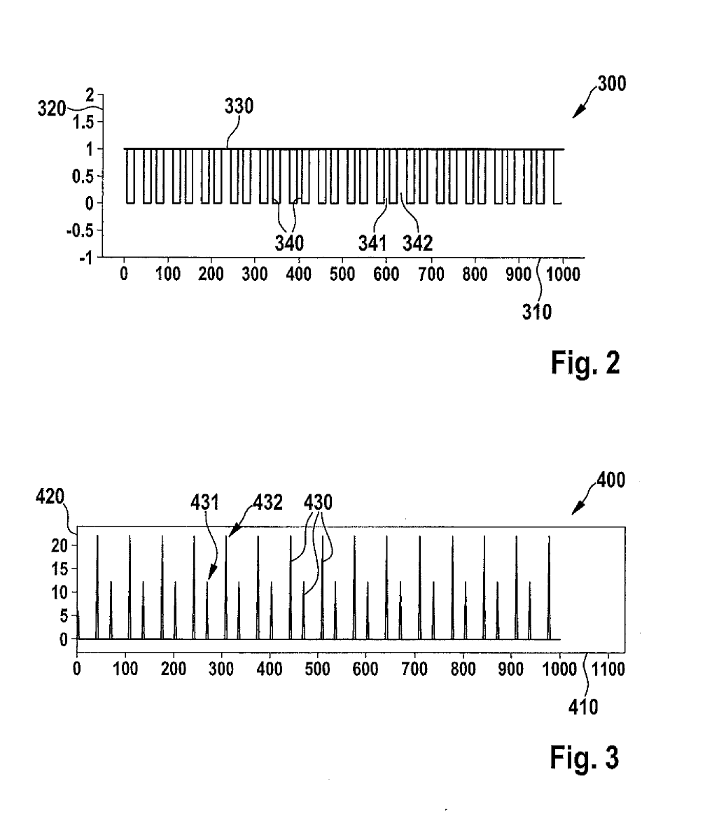

FIG. 2 shows a first diagram 300 to explain the distinction of the light of a road illumination from the light from other light sources. On a horizontal axis of first diagram 300 a time 310 is plotted in ms. On a vertical axis of first diagram 300 light intensity 320 is plotted in any desired units. An intensity graph 330 renders a course over time of an intensity of a light emitted by a light source operated using direct voltage. Intensity curve 330 is constant over time. Thus, the intensity of the light emitted by the light source does not pulsate.

Furthermore, first diagram 300 of FIG. 2 shows an exposure curve 340 of a bimodally regulated camera. The bimodally regulated camera alternatingly always takes images having a short first exposure time 341 and a long second exposure time 342.

FIG. 3 shows a second diagram 400, on whose horizontal axis a time 410 is shown in ms and on whose vertical axis a detected brightness 420 is shown in arbitrary units. The term “brightness” designates, in the context of this description, a property of the images taken by the camera from which one may infer the intensity of the light taken by the camera. More intense light leads to images having greater brightness. Similarly, a longer exposure time brings about an image having greater brightness.

An evaluation unit has evaluated the images taken according to exposure curve 340 of first diagram 300 of FIG. 2, with respect to their brightness. From this is yielded brightness curve 430 shown in second diagram 400. It may be seen that every second image taken by the camera has a low first brightness 431, while the remaining images show a high second brightness 432. The images taken at short first exposure time 341 thus have low first brightness 431. The images taken using long second exposure time 342

have high second brightness 432. An additional variation of brightness curve 430 is not present. Thus, the evaluation unit is able to draw the conclusion that the reflected light detected by the camera has an intensity that is unchangeable over time, and was thus emitted by a light source operated using direct voltage. Consequently, the light source is not a road illumination.

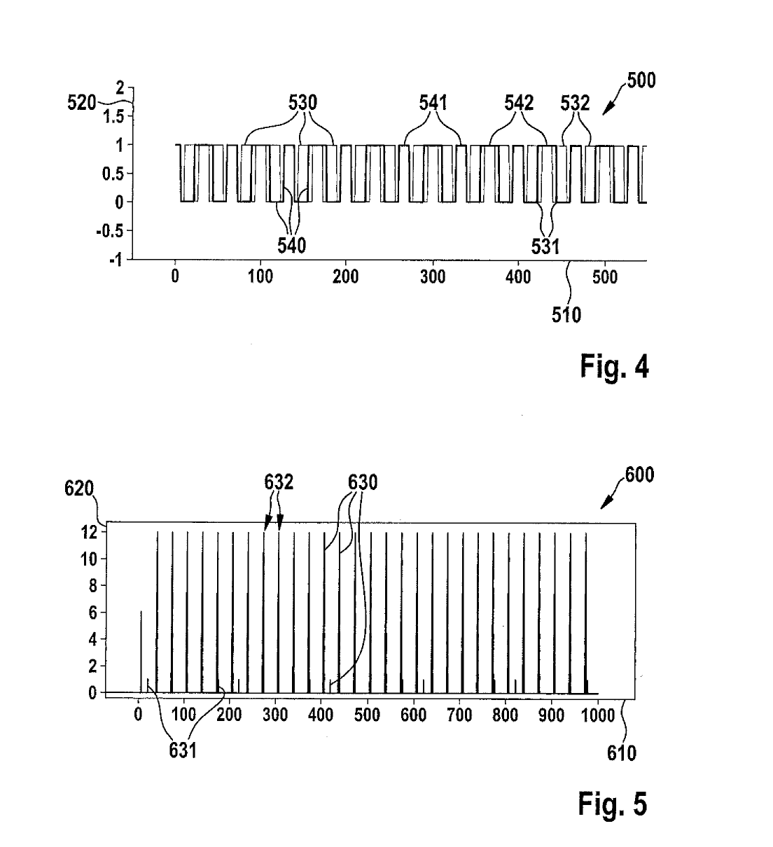

FIG. 4 shows a third diagram 500, on whose horizontal axis a time 510 is shown in ms and on whose vertical axis a light intensity 520 is plotted in arbitrary units. What is shown is an intensity curve 530 of a pulsating light source, that is, of a light source operated using alternating voltage. It may be seen that the intensity of the light emitted by the light source is oscillating between a low intensity 531 and a high intensity 532. Consequently, the light source may be a road illumination.

Shown similarly in third diagram 500 of FIG. 4 is an exposure time curve 540 of a bimodally regulated camera. Exposure time curve 540 changes back and forth between a short, first exposure time 541 and a long, second exposure time 542. Thus, the camera alternatingly always takes images having a short first exposure time 541 and a long second exposure time 542.

The change between short, first exposure time 541 and second exposure time 542 in exposure time curve 540 takes place at an established image refresh rate. The change between low intensity 531 and high intensity 532 in intensity curve 530 takes place at the network frequency of the alternating voltage network, which supplies the light source. The network frequency may, for example, amount to 50 Hz or 60 Hz. The image refresh rate of the camera may be an integral multiple of the network frequency. Consequently, the image refresh rate may amount to, for example, 50 Hz or 60 Hz, or 100 Hz or 120 Hz.

FIG. 5 shows a second diagram 600, on whose horizontal axis a time 410 is shown in ms and on whose vertical axis a detected brightness 420 is shown in arbitrary units. What is shown is a brightness curve 630 of a brightness of the images taken according to exposure time curve 540 of third diagram 500. Some images have a lower first brightness 631. Other images have a high second brightness 631. First brightness 631 and second brightness 632 do not, however, occur alternatingly. Brightness curve 630 is a function of the relationship of the frequency of intensity curve 530 and the image refresh rate of exposure time curve 540 of the camera. Intensity 530 of the light source pulsates at the network frequency of the power supply system which supplies the light source. The network frequency amounts to 50 Hz or 60 Hz, for example. The camera takes images having an image refresh rate that is dimensioned so that the network frequency is an integral multiple of the image refresh rate. From this is yielded brightness curve 630 shown in fourth diagram 600, which does not pulsate corresponding to the image refresh rate. From this one may conclude that intensity 530 of the light emitted by the light source is pulsating, that is, the light source is operated using an alternating voltage and the light source is therefore probably a road illumination.

FIGS. 2 to 5 have explained that, using a bimodally regulated camera, pulsating light sources are able to be distinguished from non-pulsating light sources if the frequency of the pulsing is an integral multiple of the image refresh rate of the camera. It is also possible, however, to distinguish pulsating light sources from non-pulsating light sources using a monomodally regulated camera. In this instance, the monomodally regulated camera should have an image refresh rate that is not an integral multiple of the network frequency at which light sources are operated.

What is claimed is:

1. A method for recognizing a road illumination, comprising:
capturing, by a camera, light reflected at a road surface; and
detecting a modulation over time of the brightness of the reflected light.

2. The method as recited in claim 1, wherein the modulation over time of the brightness of the reflected light is detected as a function of a network frequency of a power supply system.

3. The method as recited in claim 2, wherein the reflected light is captured using an at least bimodally regulated camera.

4. The method as recited in claim 3, wherein the reflected light is captured using an image refresh rate, and wherein the network frequency of the power supply system is an integral multiple of the image refresh rate.

5. The method as recited in claim 1, wherein the reflected light is captured using a monomodally regulated camera.

6. The method as recited in claim 5, wherein the reflected light is captured at an image refresh rate which is not an integral multiple of a network frequency of a power supply system.

7. A device for recognizing a road illumination, comprising:
a camera configured to capture light reflected at a road surface; and
an evaluation unit configured to detect a modulation over time of the brightness of the reflected light.

8. The device as recited in claim 7, wherein:
the camera is an at least bimodally regulated camera;
the camera has an image refresh rate;
the modulation over time of the brightness of the reflected light is detected as a function of a network frequency of a power supply system; and
the network frequency of the power supply system is an integral multiple of the image refresh rate.

9. The device as recited in claim 7, wherein:
the camera is a monomodally regulated camera;
the camera has an image refresh rate which is not an integral multiple of a network frequency of a power supply system.

10. The device as recited in claim 8, wherein the device is provided in a motor vehicle.
